(19) United States
(12) Patent Application Publication
(10) Pub. No.: US 2019/0248154 A1
(43) Pub. Date: Aug. 15, 2019

(54) DETECTION APPARATUS, INKJET RECORDING APPARATUS AND DETECTION METHOD

(71) Applicant: KONICA MINOLTA, INC., Tokyo (JP)

(72) Inventor: Kenichirou HIRAMOTO, Tokyo (JP)

(21) Appl. No.: 16/274,671

(22) Filed: Feb. 13, 2019

(30) Foreign Application Priority Data
Feb. 13, 2018 (JP) 2018-022704

(51) Int. Cl. B41J 2/21; B41J 2/005; G06T 7/00

(52) U.S. Cl. CPC B41J 2/2142; G06T 2207/30144; G06T 7/001; B41J 2/0057

(57) ABSTRACT

Provided is a detection apparatus which detects an image recording state in an inkjet recording apparatus provided with a recording head on which a plurality of ink discharging nozzles are arrayed and a transferrer including an intermediate transfer body which is impacted by discharged ink to form a primary image, the transferrer transferring the primary image on the intermediate transfer body to a recording medium and recording the image on the recording medium, the detection apparatus including a first reader which reads the primary image on the intermediate transfer body, a second reader which reads the recorded image transferred to the recording medium, and a processor. The processor sets a correspondence relation between a first detection value read by the first reader and a second detection value read by the second reader and detects the recording state of the primary image read by the first reader based on the correspondence relation.

### CROSS-REFERENCE TO RELATED APPLICATION

The present invention claims priority under 35 U.S.C. § 119 to Japanese Patent Application No. 2018-022704, filed on Feb. 13, 2018, the entire contents of which are incorporated herein by reference.

### BACKGROUND

### Technological Field

The present invention relates to a detection apparatus, an inkjet recording apparatus and a detection method.

### Description of the Related Art

There are inkjet recording apparatuses which cause ink discharged from a nozzle to hit a transfer body to form a primary image, cause the primary image to be transferred to a medium and record the image on the medium. Since many nozzles are arrayed in an inkjet recording apparatus and each nozzle discharges ink, discharge characteristics may vary among the many nozzles and defects may occur in ink discharge from the nozzles. Variations in the discharge characteristics and ink discharge defects may lead to degradation of recording images.

Conventionally, techniques of taking recording images or test images, adjusting variations and performing complementary discharge from nozzles in the periphery of a defective nozzle where an ink discharge defect occurs are known. Techniques which inkjet recording apparatuses using a transfer body detect density variations or ink discharge defects in a primary image on the transfer body, thereby restrict loss in a recording medium and speedily make corrections, are known (Japanese Patent Application Laid-Open No. 2014-54758, Japanese Patent Application Laid-Open No. 2007-230226).

However, the characteristic of an image finally recorded on a medium is not exactly the same as the characteristic of the primary image. Moreover, the transfer characteristic of the primary image to the medium can change with lapse to time. That is, there is a problem that it is not possible to appropriately evaluate the degree of deterioration of image quality of the final recording image from only the image on the primary image.

### SUMMARY

It is an object of the present invention to provide a detection apparatus, an inkjet recording apparatus and a detection method capable of appropriately and more reliably evaluating the degree of degradation of image quality of recording images.

To achieve at least one of the abovementioned objects, according to an aspect of the present invention, a detection apparatus is provided which detects an image recording state in an inkjet recording apparatus, the inkjet recording apparatus including a recording head on which a plurality of ink discharging nozzles are arrayed and a transferrer including an intermediate transfer body which is impacted by discharged ink to form a primary image, the transferrer transferring the primary image on the intermediate transfer body to a recording medium and recording the image on the recording medium, the detection apparatus including a first reader that reads the primary image on the intermediate transfer body, a second reader that reads the recorded image transferred to the recording medium, and a processor, in which the processor sets a correspondence relation between a first detection value read by the first reader and a second detection value read by the second reader and detects the recording state of the primary image read by the first reader based on the correspondence relation.

According to another aspect of the present invention, an inkjet recording apparatus is provided which includes the above detection apparatus, a recording head on which a plurality of ink discharging nozzles are arrayed, and a transferrer comprising an intermediate transfer body which is impacted by discharged ink to form a primary image, the transferrer transferring the primary image on the intermediate transfer body to a recording medium and recording the image on the recording medium.

According to a further aspect of the present invention, a detection method is provided for detecting an image recording state in an inkjet recording apparatus including a recording head on which a plurality of ink discharging nozzles are arrayed, a transferrer including an intermediate transfer body which is impacted by discharged ink to form a primary image, the transferrer transferring the primary image on the intermediate transfer body to a recording medium and recording the image on the recording medium, using a detection apparatus provided with a first reader and a second reader, the method including reading by the first reader, the primary image on the intermediate transfer body, reading by the second reader, the recorded image transferred to the recording medium, setting a correspondence relation between a first detection value read first and a second detection value read second and detecting the recording state from the primary image read by the first reader based on the correspondence relation.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a front view schematically illustrating an overall configuration of an inkjet recording apparatus;

FIG. 2A is a bottom view illustrating an ink discharge surface of a head unit;

FIG. 2B is an enlarged view of the ink discharge surface;

FIG. 3 is a block diagram illustrating a functional configuration of the inkjet recording apparatus;

FIG. 4A is a diagram illustrating an example of a test image;

FIG. 4B is a diagram illustrating an example of part of a test image reading result;

FIG. 5A is a diagram describing an abnormality detection reference for a recorded image;

FIG. 5B is a table describing an abnormality detection reference for a recorded image;

FIG. 6 is a flowchart illustrating a control procedure of an abnormality detection reference setting process executed in the inkjet recording apparatus;

FIG. 7 is a diagram illustrating an example of an image recorded on a recording medium during a normal image recording operation;

FIG. 8 is a flowchart illustrating a control procedure of an abnormality detection control process executed in the inkjet recording apparatus;

FIG. 9A is a diagram describing a modification 1 of a test image;

FIG. 9B is a diagram describing the modification 1 of a test image;

FIG. 10A is a table illustrating an example of an abnormality detection reference table corresponding to the modification 1;

FIG. 10B is a table illustrating an example of an abnormality detection level setting corresponding to the modification 1;

FIG. 11A is a diagram illustrating a modification 2 of a test image;

FIG. 11B is a diagram illustrating the modification 2 of a normal image;

FIG. 12A is a diagram illustrating a modification 3 of a test image; and

FIG. 12B is a diagram illustrating the modification 3 of a test image.

### DETAILED DESCRIPTION OF EMBODIMENTS

Hereinafter, one or more embodiments of the present invention will be described with reference to the drawings. However, the scope of the invention is not limited to the disclosed embodiments.

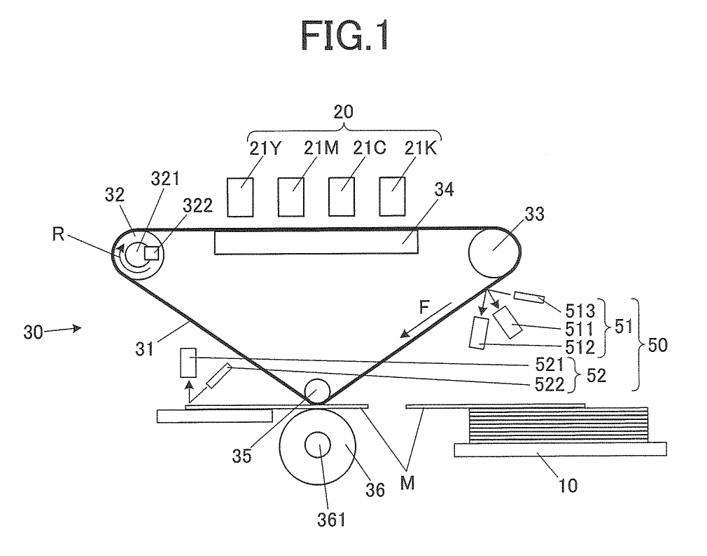

FIG. 1 is a front view schematically illustrating an overall configuration of an inkjet recording apparatus 1 of the present embodiment.

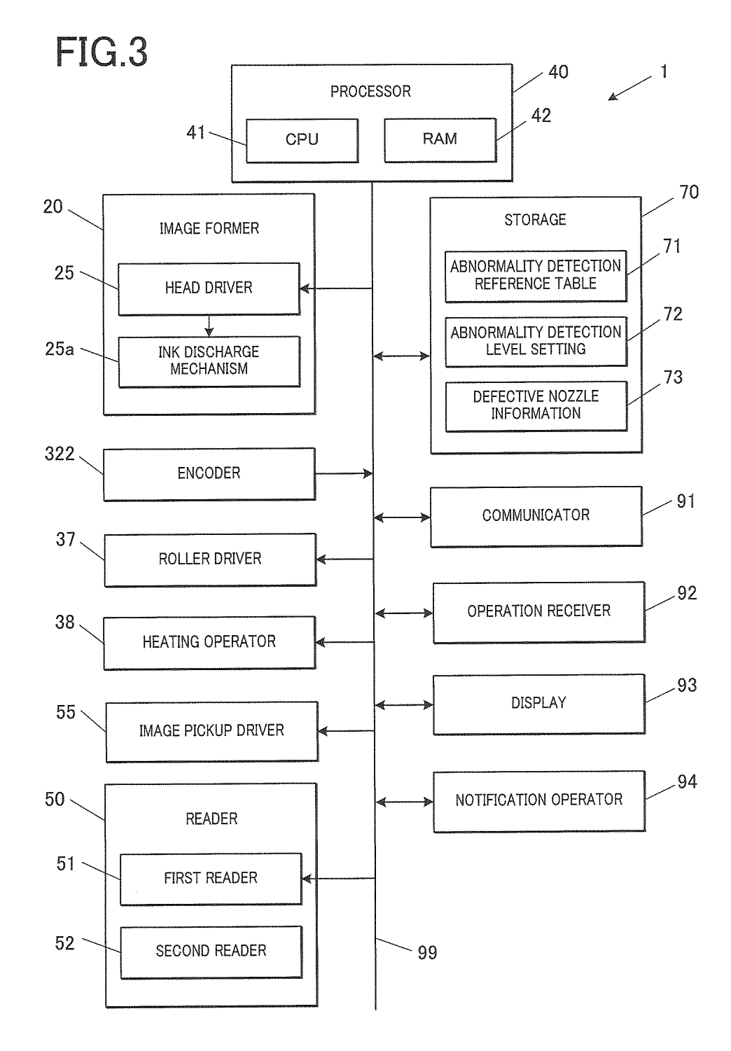

The inkjet recording apparatus 1 according to the present embodiment having a detection apparatus that executes a detection method of the present embodiment is provided with a medium supplier 10, an image former 20, a transferrer 30, a processor 40 (see FIG. 3), a reader 50 and the like.

The medium supplier 10 stores a plurality of recording media M, supplies the recording media M to a transfer position of the transferrer 30 sequentially and discharges the recording media M to which primary images are transferred. The medium supplier 10 is provided with a medium storage and a supply roller or the like which are not shown. The medium storage stores a plurality of recording media M stacked one on another, and one at the top of the plurality of recording media M stored in the medium storage is sent out by the supply roller.

Various media such as paper, resin plate, metal, cloth, rubber can be used as the recording media M. Examples of paper include normal paper, cardboard, coated paper, resin coat sheet and synthetic paper.

The image former 20 discharges ink from nozzles onto an outer circumferential surface (image forming surface) of an intermediate transfer belt 31 based on image data and forms a primary image on the image forming surface. The image former 20 includes four head units 21Y, 21M, 21C and 21K (any one or all of which is/are also denoted as “head unit 21”) corresponding to a plurality of colors of ink, here four colors of yellow (Y), magenta (M), cyan (C) and black (K). Ink discharge surfaces of the plurality of head units 21 are arranged opposed to the image forming surface at an appropriate interval.

A plurality of nozzle openings are arranged in a width direction (e.g., orthogonal direction) crossing the moving direction of the intermediate transfer belt 31 over an image recording width on the ink discharge surface of each head unit 21, constituting a line head. This makes it possible to form a primary image in a single path scheme as the intermediate transfer belt 31 moves. Examples of an ink discharge mechanism from each nozzle include a piezo system using a piezoelectric element and a thermal system in which ink is heated and jetted out.

The transferrer 30 causes the intermediate transfer belt 31 and the recording media M to move and come into contact with each other so that the primary image formed on the intermediate transfer belt 31 is transferred to the recording media M. The transferrer 30 is provided with the intermediate transfer belt 31 (intermediate transfer body), a drive roller 32, a driven roller 33, a supporter 34, a pressurizing roller 35, a heating roller 36 or the like.

Ink discharged from the image former 20 impacts the intermediate transfer belt 31, a primary image is thereby formed on the intermediate transfer belt 31 and the primary image is transferred to the recording media M. The intermediate transfer belt 31 is, for example, an endless belt wound around the drive roller 32, the driven roller 33 and the pressurizing roller 35, and the intermediate transfer belt 31 makes circulating movement (here, an arrow F direction corresponds to a feeding direction) following the rotating operation of the drive roller 32.

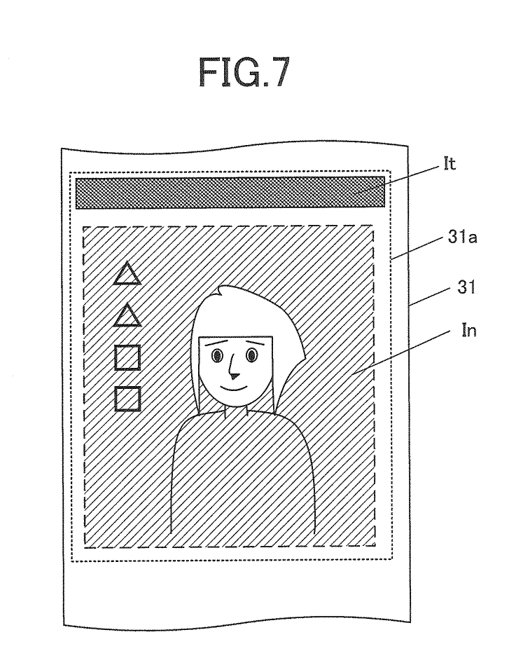

One or a plurality of image forming regions 31a (see FIG. 7) is/are defined in which the primary image is formed in advance periodically on the image forming surface of the intermediate transfer belt 31. The image forming region 31a is formed of resin and/or metal which no rubber resin liquid or ink droplet permeates. More specifically, examples of the material of the image forming region 31a include publicly known materials such as polyimide-based resin, silicon-based resin, polyurethane-based resin, polyester-based resin, polystyrene-based resin, polyolefin-based resin, polybutadiene-based resin, polyamide-based resin, polyvinyl chloride-based resin, polyethylene-based resin, and fluorine-based resin.

The intermediate transfer belt 31 has a multilayer structure and may include a support layer having predetermined rigidity on an underside of the image forming surface (inner surface side of circulating movement). At least the image forming region 31a of the image forming surface is configured to constitute a horizontal surface having predetermined flatness.

The drive roller 32 rotates around a rotary shaft driven by a motor (not shown) (here, normally the direction shown by an arrow R). An encoder 322 (rotary encoder) is provided on the rotary shaft of the drive roller 32, which outputs a signal corresponding to the amount of rotation to a processor 40. Furthermore, the drive roller 32 incorporates a heating member 321 such as a halogen heater. In this way, the intermediate transfer belt 31 is heated as it makes circulating movement.

The driven roller 33 is disposed at a predetermined distance from the drive roller 32 and rotates around a rotary shaft parallel to a rotary shaft of the drive roller 32 as the intermediate transfer belt 31 makes circulating movement.

The supporter 34 supports the intermediate transfer belt 31 over at least part of the range in which the intermediate transfer belt 31 faces the ink discharge surface of the head unit 21 from the inner surface side. In this way, the distance between the image forming surface of the intermediate transfer belt 31 and the ink discharge surface of the head unit 21 is kept constant. A suction port may be provided in the supporter 34 so as to suction air on the outer circumferential surface side through the suction port to prevent the intermediate transfer belt 31 from floating from the supporter 34.

The intermediate transfer belt 31 is stretched by the pressurizing roller 35. The pressurizing roller 35 may also be movably provided so as to absorb deflection of the intermediate transfer belt 31.

The heating roller 36 is disposed so as to form a nip N between the heating roller 36 and the pressurizing roller 35. The intermediate transfer belt 31 and the recording medium M are pinched in this nip N, the primary image on the image forming surface of the intermediate transfer belt 31 is transferred to the recording medium M and the image is thereby recorded on the recording medium M. A heating member 361 such as a halogen heater is provided in the heating roller 36. The recording medium M pinched in the nip N is pressurized by the pressurizing roller 35 against the intermediate transfer belt 31 at a predetermined pressure while being heated by the heating roller 36. In this way, the primary image formed on the intermediate transfer belt 31 is appropriately transferred to the recording medium M.

The reader 50 is provided with a first reader 51 that reads the primary image formed on the image forming surface of the intermediate transfer belt 31 and a second reader 52 or the like that reads the image (recorded image) transferred to the recording medium M.

The first reader 51 is provided with image capturers 511 and 512 and an illuminator 513 or the like. The image capturers 511 and 512 are each provided with an image pickup sensor that picks up the primary image formed on the image forming surface of the intermediate transfer belt 31. As the image pickup sensor, a CCD sensor or a CMOS sensor or the like in which a plurality of image pickup devices are arrayed one-dimensionally in the width direction is used, and it is possible to acquire a two-dimensional image if necessary by acquiring image pickup data in an appropriate cycle for circulating movement of the intermediate transfer belt 31. Image pickup areas of the image capturers 511 and 512 are substantially identical and determined be at positions downstream of a range of impact onto the intermediate transfer belt 31 of the ink discharged from the image former 20 in the circulating movement direction of the intermediate transfer belt 31 and upstream of the nip N to which the primary image is transferred.

The first reader 51 may be configured so that image readable areas, that is, the image pickup areas by the image capturers 511 and 512 may be wider than not only the width of the image forming region 31a (see FIG. 7) on the intermediate transfer belt 31 but also the width of the intermediate transfer belt 31 itself. This allows the first reader 51 to detect a positional displacement in the width direction during circulating movement of the intermediate transfer belt 31 and allows the read image to be corrected according to the amount of displacement. Note that instead of detecting both ends in the width direction of the intermediate transfer belt 31, the intermediate transfer belt 31 may be provided with a label indicating a reference position in the width direction, the first reader 51 may detect the label and thereby detect a positional displacement of the intermediate transfer belt 31.

The illuminator 513 illuminates the image pickup areas by the image capturers 511 and 512 on the circulating path of the intermediate transfer belt 31. The illuminator 513 causes light to enter the image pickup area (normal vector of the image pickup area) at an angle of 45 degrees to illuminate the image pickup area. The image pickup sensors of the image capturers 511 and 512 perform image pickup at a light receiving angle of 0 degrees (that is, reflected light in a direction perpendicular to the image pickup area is detected) and at a light receiving angle of 45 degrees (that is, the direction in which reflected light in a direction at 90 degrees with respect to the incident light on the image pickup area from the illuminator 513 is detected) to the image pickup area. The image capturer 511 that performs image pickup at the light receiving angle of 0 degrees is more likely to accurately acquire a value corresponding to the density and the image capturer 512 that performs image pickup at the light receiving angle of 45 degrees is more likely to accurately acquire a value corresponding to a glossiness component. By combining these image capturers, the amount of ink adhered and the degree of glossiness can be grasped accurately. Note that the above-described 0 degrees, 45 degrees and 90 degrees are not limited to accurate values, but there may be a certain degree of misalignment. Instead of differentiating the light receiving angles, a polarization filter may be used so that one image capturer can detect a value appropriately corresponding to a density value or a value corresponding to the degree of glossiness.

The second reader 52 is provided with an image capturer 521 and an illuminator 522 or the like. The image capturer 521 has a configuration similar to that of the image capturer 511 and picks up a one-dimensional image of the recorded image transferred to the recording medium M through a line sensor. The illuminator 522 illuminates the image pickup area of the recorded image by the image capturer 521. Here, the angle of incidence of the illumination light by the illuminator 522 on the image pickup area is 45 degrees and the light receiving angle of the reflected light detected by the image capturer 521 is 0 degrees. There may be a certain degree of misalignment between them or the image capturer 521 and the illuminator 522 may be provided in a positional relationship different from their positional relationships. An image capturer for detecting 90-degree reflected light of the incident light by the illuminator 522 may also be provided together with the image capturer 521 as in the case of the first reader 51.

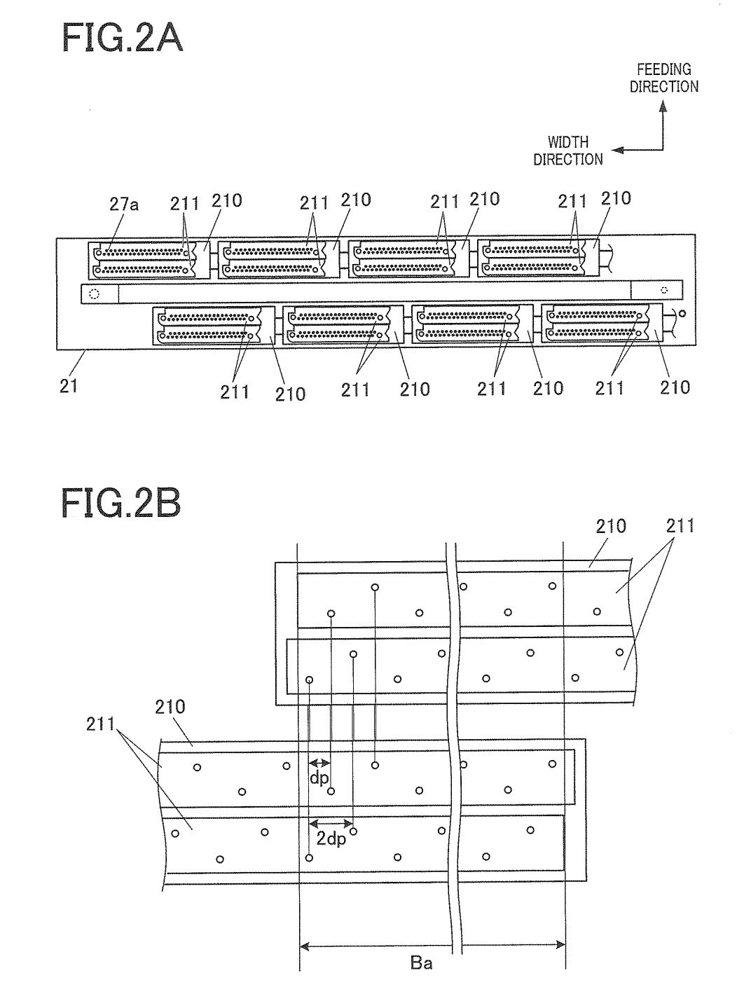

FIG. 2A is a bottom view illustrating the ink discharge surface of the head unit 21. Each head unit 21 has eight head modules 210 and these head modules 210 are arranged in a staggered pattern. Each head module 210 includes two recording heads 211 arranged at different positions in the feeding direction and a plurality of nozzles are arranged so that nozzle openings 27a are arranged on the bottom faces of the recording heads 211, respectively. Thus, the sixteen recording heads 211 form a line head.

FIG. 2B is an enlarged view of the ink discharge surface. The nozzle openings 27a are provided at an interval twice (2 dps) a predetermined interval dp in the width direction on each recording head 211, and since the two recording heads 211 are disposed, displaced by a predetermined interval dp in the width direction in the head module 210, the respective nozzle openings 27a are arranged at the predetermined interval dp in the width direction as a whole. The respective head modules 210 are arranged in such a positional relationship that their arrangement ranges of the nozzle openings 27a partially overlap with the neighboring head module 210 over a section Ba in the width direction.

FIG. 3 is a block diagram illustrating a functional configuration of the inkjet recording apparatus 1.

The inkjet recording apparatus 1 is provided with a processor 40 (reference setter, state detector, corrector), a head driver 25, a roller driver 37, a heating operator 38, the above-described encoder 322 and the reader 50, an image pickup driver 55, a storage 70, a communicator 91, an operation receiver 92, a display 93, a notification operator 94, a bus 99 or the like.

The processor 40 integrally controls an overall operation of the inkjet recording apparatus 1. The processor 40 is provided with a CPU 41 (Central Processing Unit) and a RAM 42 (Random Access Memory) or the like. The CPU 41 performs various kinds of operation processing. The CPU 41 reads various control programs stored in the storage 70 and controls image recording operation and abnormality detection operation on recorded images or the like in the inkjet recording apparatus 1.

The processor 40 and the reader 50 (the first reader 51 and the second reader 52) constitute the detection apparatus of the present embodiment.

The storage 70 stores various control programs to be executed by the processor 40, setting data and image data of images to be recorded or the like. The storage 70 is provided with a non-volatile semiconductor memory and HDD (Hard Disk Drive) or the like. The storage 70 may also be provided with a volatile DRAM or the like so as to be used for image processing and update processing on setting data or the like.

The setting data stored in the storage 70 includes an abnormality detection reference table 71, an abnormality detection level setting 72, defective nozzle information 73 or the like. The abnormality detection reference table 71 and the abnormality detection level setting 72 are information associated with a reference to be used for detection of defect nozzles and will be described later. The defective nozzle information 73 stores a list of identified defective nozzle identification information.

The head driver 25 generates a drive signal associated with an ink discharge operation from a nozzle and outputs the drive signal to an ink discharge mechanism 25a of the head unit 21 at appropriate timing corresponding to a count number of pulse signals inputted from the encoder 322 attached to the drive roller 32. The head driver 25 outputs a drive signal associated with an ink discharge operation on the ink discharge mechanism 25a based on the control signal and image data to be recorded from the processor 40.

The roller driver 37 outputs a drive signal for causing a motor that rotates the drive roller 32 to perform rotation operation at a set speed. The rotation speed of the drive roller 32 is kept to a constant speed during normal operation, but the setting can be changed according to resolution of the recorded image or the like. Furthermore, instead of moving the recording medium M at a constant speed, the roller driver 37 can also change the rotation speed of the motor in a pulse shape so as to move intermittently.

The heating operator 38 performs switching operation of power supply to the heating members 321 and 361. The heating operator 38 performs operation of switching operation (heat generation) of the heating members 321 and 361 based on the temperature in a predetermined region of the drive roller 32 and the heating roller 36 measured by a temperature sensor (not shown). The switching operation may be a simple on/off operation or can be changed in a stepped form in a plurality of stages or may be subjected to PWM control (Pulse Width Modulation) through an on/off operation at a high frequency.

The image pickup driver 55 causes the illuminators 513 and 522 to perform illumination operation and causes the image capturers 511, 512 and 521 to perform image pickup operation. The brightness of the illuminators 513 and 522 in the illumination operation may be constant or changeable in a plurality of stages. The image pickup cycle by each line sensor of the image capturers 511, 512 and 521 may be changeable as appropriate.

The communicator 91 performs control associated with communication carried out with an external device, mainly control associated with transmission/reception of data. The communicator 91 is provided with a network card or the like and performs communication control according to a predetermined communication standard. The data to be received includes image data to be recorded and job data including an operation setting or the like relating to recording operation of the image data. The data to be transmitted includes status information or the like relating to progress of image recording operation corresponding to the job data.

The operation receiver 92 receives an input operation from outside. The operation receiver 92 is provided with operation keys, a touch panel or the like disposed superimposed on a display screen of the display 93. The operation receiver 92 converts each input operation to a corresponding electric signal and outputs the electric signal to the processor 40.

The display 93 performs various operations of display such as a status and operation menu based on the control of the processor 40. The display 93 is provided with a display apparatus such as a liquid crystal display or an organic EL display.

The notification operator 94 performs predetermined notification operation based on the control of the processor 40. Examples of the notification operation include sound output such as a beep sound, lighting and blinking operations of LED lamps, and of these operations, the notification operator 94 includes a sound output circuit and LED lamps, part or whole of which can be operated by the inkjet recording apparatus 1.

The bus 99 is a signal path for transmitting/receiving signals between the processor 40 and each section.

A cleaner for cleaning the image forming surface of the intermediate transfer belt 31 may be provided between the nip N and the drive roller 32 in the feeding direction of the intermediate transfer belt 31. As the cleaning member, cloth, non-woven fabric, blade member or the like may be used. The apparatus may also be configured to provide a cleaning liquid for peeling ink or stain or the like onto the image forming surface or the cleaning member.

Next, the abnormality detection operation by the inkjet recording apparatus 1 according to the present embodiment will be described.

In the inkjet recording apparatus 1, a test image in which discharge defects have been produced in a predetermined pattern in advance is formed, the first reader 51 reads the formed primary image and the second reader 52 reads a recorded image on the recording medium to which the primary image has been transferred. A brightness change in the first reader 51 corresponding to the degree of defects (brightness change) that falls below an image quality reference in the reading result of the second reader 52 is acquired and set as a reference value (primary image reference value). During normal image recording, a predetermined abnormality detection pattern image is outputted to a blank space of the recording media M. Images (primary images) transferred to or recorded or expected to be recorded on the recording media M which fall below the image quality reference are detected based on a comparison between the reading result obtained by the first reader 51 reading a primary image of this pattern image (that is, the degree of brightness change amount) and the aforementioned primary image reference value.

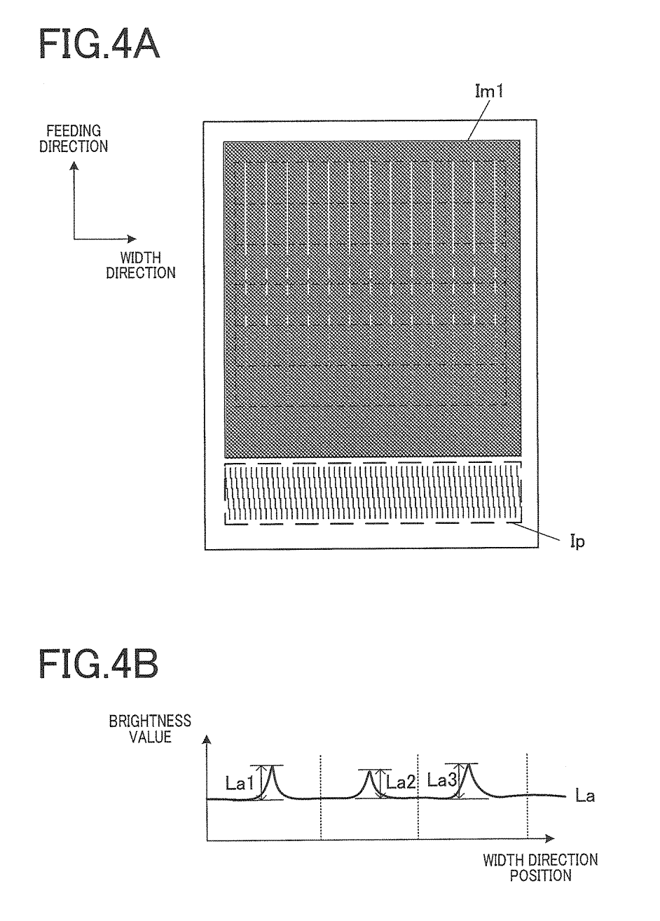

FIG. 4A is a diagram illustrating an example of a test image Im1. FIG. 4B is a diagram illustrating an example of part of a reading result of the test image Im1.

As shown in FIG. 4A, the test image Im1 here is obtained by determining nozzles not allowed to perform ink discharge (non-discharge nozzles) in the width direction at a predetermined interval for a half-tone image with uniform density using respective ink colors (image with a predetermined density) and creating a linear portion corresponding to ink discharge abnormality (non-discharge nozzle corresponding portion) extending in the feeding direction. A plurality of such images are provided in the feeding direction of the intermediate transfer belt 31 in a stepped form by a predetermined width, the thickness of the non-discharge nozzle corresponding portion being changed at each step. More specifically, the thickness is gradually finely determined in order of “2”→“1”,→“¾”→“⅔”→“½”→“⅓”→“¼”→ . . . from the top. The thickness of less than one nozzle defect means a gap produced due to the fact that the ink discharge direction from the nozzle opening 27a is polarized (varies) mainly in the width direction (direction crossing the feeding direction) and here, the discharge frequency (predetermined frequency) from the nozzle corresponding to the non-discharge nozzle corresponding portion is adjusted. That is, when the thickness of a nozzle defect is ⅔, it is determined so that ink is not discharged from the nozzle twice every three times on average. Although timing at which ink is not discharged from the non-discharge nozzle corresponding portion is not particularly limited, the timing may be set randomly.

An image Ip for identifying the positions of the neighboring discharge defective nozzles is recorded in this test image Im1. When defective nozzles with ink discharge defects really exist among the nozzles used for recording the test image Im1 and if no complementary setting or the like is done, a density change occurs even at the position of the defective nozzle in addition to the nozzle position at which ink is intentionally not allowed to be discharged. Therefore, if the reading value of the test image Im1 is used as is, it is no longer possible to acquire an appropriate density distribution. The position identifying image Ip is used to confirm that there is no defective nozzle in which the nozzle used to record the test image Im1 is not subjected to any complementary setting. As the position identifying image Ip, images for which respective independent lines and dots from each nozzle are recorded at the respective predetermined positions are used. In this way, the presence or absence of ink discharge is determined and the positions where ink is not discharged are identified. The positional relationship between the test image Im1 and the position identifying image Ip (front-back relationship or up-down relationship in FIG. 4A) may be reversed.

When brightness values are averaged in the feeding direction in each step and a brightness distribution is taken in the width direction, the brightness values periodically change in the non-discharge nozzle corresponding portion as shown in FIG. 4B. This brightness distribution is separated into individual areas (dotted line) at a setting interval of the non-discharge nozzle corresponding portions, where a difference between a minimum value and a maximum value of brightness values in each area, and a brightness difference value La (here, La1 to La3) such as a normal image portion and a maximum value such as an average value of a portion where the brightness value does not greatly change near a local minimum value are acquired. An average value and a median or the like of the plurality of brightness difference values La acquired of the non-discharge nozzle corresponding portion of a certain thickness are determined as a brightness change amount corresponding to the thickness of the non-discharge nozzle corresponding portion. Note that instead of using a detection value of each image pickup device as is, for example, a moving average value obtained by averaging detection values of a predetermined number of (2 or more) pixels in the width direction may be used as a brightness value of each pixel.

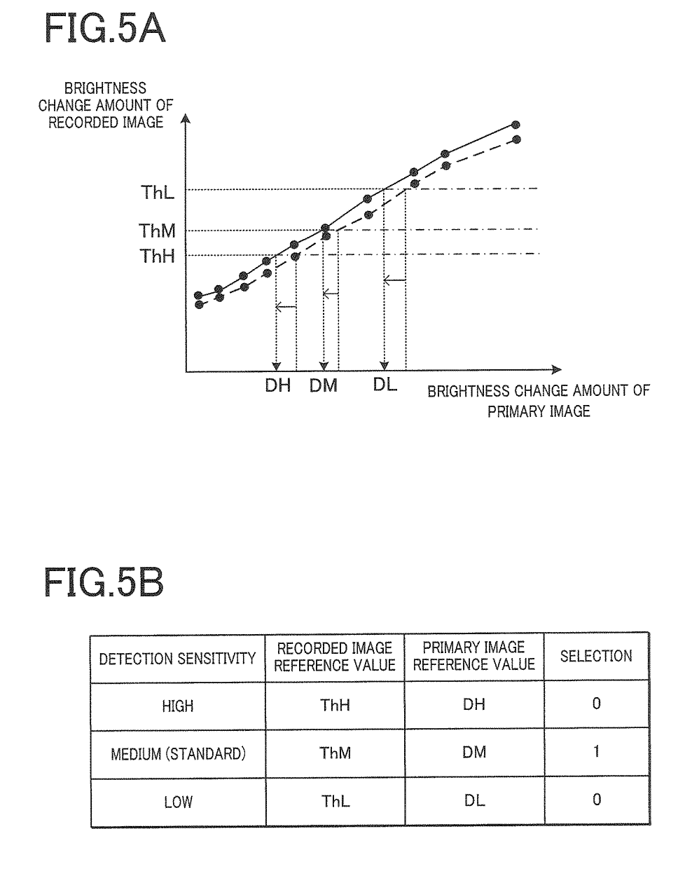

FIG. 5A and FIG. 5B are a diagram and a table describing an abnormality detection reference for an image recorded in the inkjet recording apparatus 1.

A brightness distribution when a primary image on the intermediate transfer belt 31 is read is different from a brightness distribution when a recorded image transferred to the recording media M is read due to differences in a transfer characteristic, transfer efficiency and each surface physical property or the like. As shown in FIG. 5A, by reading the test images Im1 respectively, a correspondence relation between a value on the primary image (first detection value) and a value on the recorded image (second detection value) corresponding to the thickness of a nozzle defect is obtained for a change amount of the brightness value (amount of the brightness change) in the non-discharge nozzle corresponding portion in the test image Im1. This corresponds to the abnormality detection table 71.

The magnitude of a finally allowable brightness change (reference value: predetermined detection reference) is defined on the recorded image. The reference value may be changed according to the type of image to be outputted, the type of the recording medium and the image quality required for the image or the like. Here, as shown in FIG. 5B, a plurality of types, for example, three types of high, medium (standard) and low are set as detection sensitivity, and any one setting may be selected in accordance with the user's input operation via the operation receiver 92 and setting instructions included in a job setting acquired via the communicator 91. Here, a flag “1” is set indicating that a medium (standard) level is selected as detection sensitivity and flag “0” indicating a non-selected state is set for other high sensitivity and low sensitivity.

The operation receiver 92 and the communicator 91 constitute an input receiver of the present embodiment that receives an external input.

When the magnitudes (recorded image reference values) allowable for a brightness change amount on the recorded image at three types of sensitivity are assumed to be reference values ThL, ThM and ThH (second reference values) respectively, detection reference values DL, DM and DH (first reference values) which are allowable values (primary image reference values) of the brightness change amount (first detection values) on the primary image corresponding to these reference values ThL, ThM and ThH respectively are determined from the graph obtained in FIG. 5A. This corresponds to the abnormality detection level setting 72. Note that since the respective brightness change amounts can be acquired only discretely, if the respective brightness change amounts do not coincide with the values of brightness change amounts for which the reference values ThL, ThM and ThH are acquired, corresponding primary image reference values may be acquired by linear interpolation or fitting as appropriate. The absolute values of the brightness change amounts on the primary image vary with lapse of time as shown by a broken line and a straight line in FIG. 5 respectively in the acquisition results at different timings. Therefore, by acquiring and updating the relationship between the reference values ThL, ThM and ThH and the detection reference values DL, DM and DH with an appropriate frequency and by making a comparison with the primary image reading result using any one of the detection reference values, it is possible to appropriately determine image quality abnormality of the final recorded image from the primary image (determine whether or not the recorded image satisfies a predetermined detection reference).

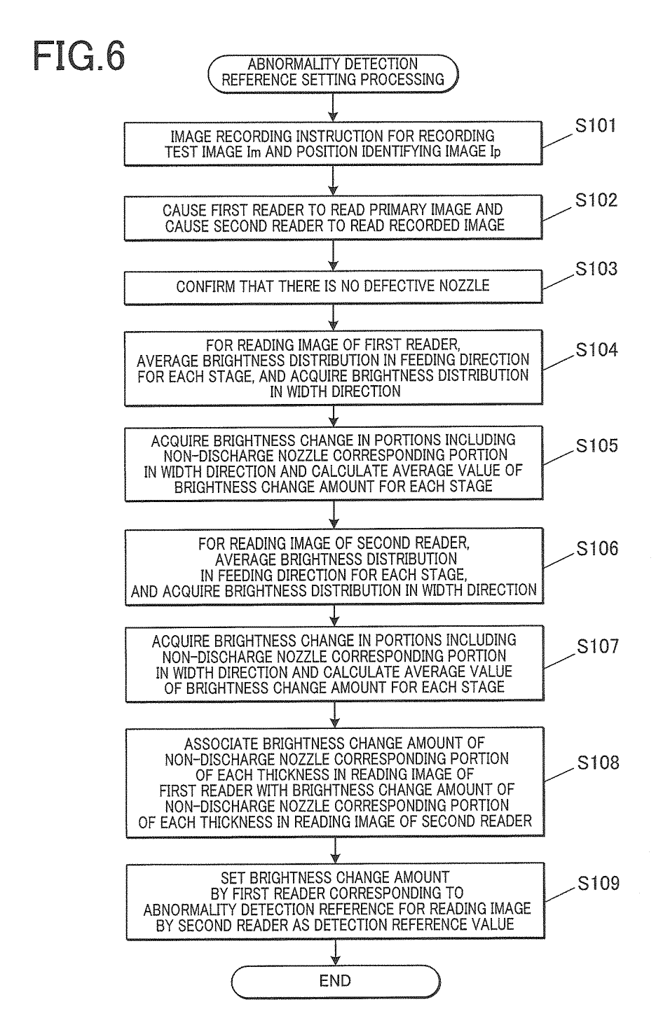

FIG. 6 is a flowchart illustrating a control procedure by the processor 40 of an abnormality detection reference setting process executed in the inkjet recording apparatus 1.

This abnormality detection reference setting process is automatically started when the inkjet recording apparatus 1 is started, periodically, for example, once every predetermined number of times (can be every time including initial starting), every time the number of recorded images reaches a predetermined number of images or every time a predetermined time elapses after execution of the previous process, or based on the user's predetermined input operation on the operation receiver 92. The starting frequency is normally lower than the starting frequency of an abnormality detection control process which will be described later.

When the abnormality detection reference setting process is started, the processor 40 causes the medium supplier 10, the image former 20 and the transferrer 30 to operate and causes the test image and the position identifying image Ip to be recorded on the recording media M via the intermediate transfer belt 31 (step S101). By operating the reader 50, the processor 40 causes the first reader 51 to read the primary image on the intermediate transfer belt 31 (first reading step) or causes the second reader 52 to read the recorded image on the recording media M (second reading step) (step S102).

The processor 40 confirms from the image pickup data of the position identifying image Ip that no discharge defective nozzle has been detected (step S103). The processor 40 integrates and averages brightness of reading images of the primary image (first reading image) in the feeding direction for each stage (thickness of the non-discharge nozzle corresponding portion) and acquires a brightness distribution in the width direction for each stage (step S104). The processor 40 calculates a difference in brightness values from the periphery thereof for a plurality of non-discharge nozzle corresponding portions in each stage of the first reading image and calculates an average value of these difference values for each stage (thickness) (step S105).

The processor 40 integrates and averages brightness in the feeding direction for each stage (thickness of the non-discharge nozzle corresponding portion) for the reading images of the recorded image (second reading image) and acquires a brightness distribution in the width direction for each stage (step S106). The processor 40 calculates differences in brightness values from the periphery thereof for a plurality of non-discharge nozzle corresponding portions in each stage in the second reading image and calculates an average value of these difference values for each stage (thickness) (step S107).

The processor 40 associates the average value of the difference value (first detection value) associated with the first reading image with the average value of the difference value (second detection value) associated with the second reading image, sets the associated value as the abnormality detection reference table 71 (correspondence relation) and stores the value in the storage 70 (step S108). When old table data is stored, the table data may be overwritten and updated. The processes in steps S104 to S108 constitute a reference setting step of the present embodiment (operation of the processor 40 as a reference setter).

The processor 40 sets brightness change amounts corresponding to the first reading image by the first reader corresponding to reference values ThL, ThM and ThH which are abnormality detection references for the second reading image by the second reader 52 as detection reference values DL, DM and DH and stores them as the abnormality detection level setting 72 in the storage 70 (step S109). The processor 40 then ends the abnormality detection reference setting process.

Note that at the initial starting, before performing the above-described abnormality detection reference setting process, adjustments (initial adjustments) are made between the positions of the nozzle openings 27a in the head unit 21, variations in the feeding direction of the ink discharge direction from the nozzle openings 27a, relative positions among the plurality of head modules 210, periodic fluctuation of the rotation phase and the moving speed of the intermediate transfer belt 31 and the positions of the image pickup devices of the first reader 51 and the second reader 52.

A first factor of positional displacement is an inclination in the feeding direction of the mounting position of the head module 210. The processor 40 forms a predetermined measurement pattern on the intermediate transfer belt 31 for causing the plurality of nozzles provided at the identical position in the feeding direction of each head module 210 to discharge ink. The processor 40 causes the first reader 51 to read the primary image formed, calculates the inclination with respect to the feeding direction and thereby determines the inclination of the head module 210. With respect to this inclination, the processor 40 may perform, for example, a delay process for shifting timing of ink discharge from each nozzle to make an adjustment so that recording is performed at the identical position in the feeding direction on the intermediate transfer belt 31. Alternatively, the processor 40 may cause the display 93 to display an amount of adjustment corresponding to the inclination of each head module 210 and cause a user, administrator, or maintenance personnel to mechanically fine-adjust the mounting position of the head module 210 according to the amount of adjustment. The processor 40 may also cause large deviations to be mechanically adjusted and the processor 40 may set and adjust a delay amount corresponding to the remaining deviations.

For variations in the feeding direction of the direction of ink discharge from the nozzle openings 27a, the processor 40 causes ink to be discharged in a pattern in which dots are independently formed from the respective nozzle openings 27a of the head module 210, inclination of which is adjusted. The processor 40 measures a displacement from the reference position in the feeding direction for each nozzle and identifies the magnitude of variations. The processor 40 may further correct the delay amount associated with ink discharge timing from each nozzle according to the identified magnitude of variations from the delay amount set in the above-described delay process.

Furthermore, the head modules 210 adjacent to each other in the width direction overlap each other in the width direction in the area where the nozzle openings 27a are disposed as described above. By causing ink to be complementarily discharged from any one nozzle in a predetermined pattern in this overlapping portion, discontinuation in the connection parts between parts of the primary image formed by each head module 210 is reduced. After the delay amount is corrected, the processor 40 causes the head unit 21 to perform ink discharge in a predetermined pattern associated with the acquisition of relative positions from at least some of the nozzle openings 27a in the overlapping portion (section Ba) in the width direction of each head module 210. The processor 40 then identifies an amount of displacement from the designed position and sets an adjustment associated with assignment of image data to each head module 210. The adjustment associated with the assignment may also include an amount of adjustment of output values associated with the adjustment of the discharge amount corresponding to a relative positional displacement of less than 1 dot.

The processor 40 further causes ink to be discharged at a predetermined nozzle interval (every N nozzles) in the width direction and identifies distortion of the array interval of the image pickup range by each image pickup device in the image capturers 511, 512 and 521 through reading by the first reader 51 and the second reader 52. This makes it possible to accurately determine the actual range in which each image pickup device picks up images.

In addition to the case where the inkjet recording apparatus 1 is started for the first time, the above-described initial adjustment may be performed over again when the head unit 21, the head module 210, and the image capturers 511, 512 and 521 are replaced. Furthermore, the primary image formed in such cases of adjustment may be colored in advance with a color different from the color discharged from the head unit 21 to be adjusted so that a predetermined background color is obtained as in the case of the test image Im1. In this case, the transferrer 30 may be operated so that ink is neither transferred at the nip N, nor is cleaned (removed) even by the cleaner but the ink adhered to the intermediate transfer belt 31 in the previous circulation is carried over to the next circulating movement.

FIG. 7 is a diagram illustrating an example of an image recorded on a recording medium during a normal image recording operation.

Once detection reference values DL, DM and DH of the abnormality detection level setting 72 are set and any one detection reference value is used or (detection sensitivity) is defined based on the user operation, job setting or the like, the inkjet recording apparatus 1 detects the likelihood of occurrence of a density variation equal to or higher than an allowable reference value in the recorded image based on only the reading result by the first reader 51 of the abnormality detection image It formed on the intermediate transfer belt 31 together with a normal image In to be recorded, and takes possible measures. The abnormality detection image It is a predetermined density, here a half-tone image with a density identical to the background density of the test image Im1.

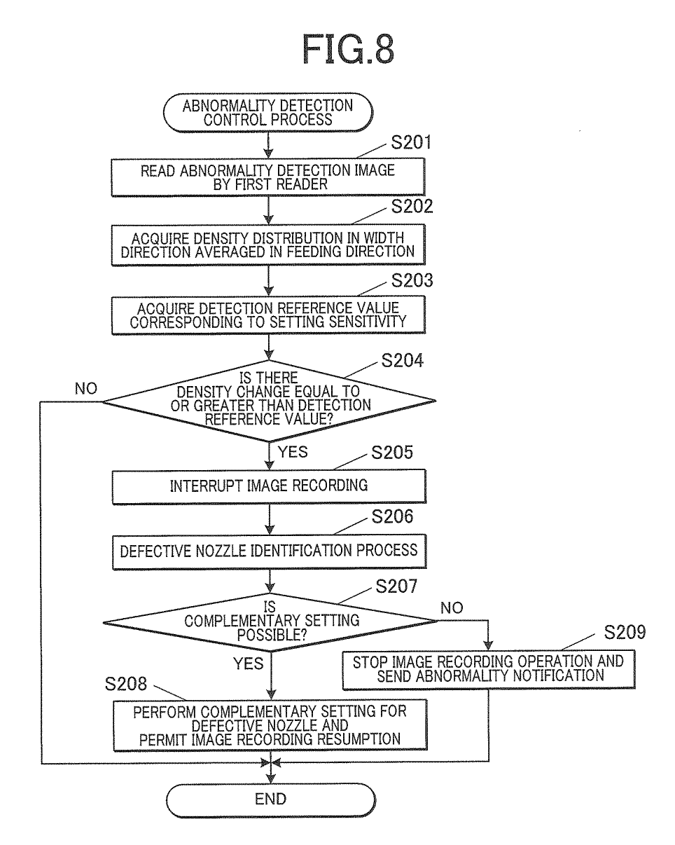

FIG. 8 is a flowchart illustrating a control procedure by the processor 40 for an abnormality detection control process executed in the inkjet recording apparatus 1.

This abnormality detection control process is repeatedly started every time the abnormality detection image It is recorded together with the normal image In. The abnormality detection image It may be recorded in combination with all normal images In or the abnormality detection image It may be inserted and recorded every time a predetermined number of normal images In are outputted.

Once the abnormality detection control process is started, the processor 40 (CPU 41) causes the first reader 51 to perform reading operation on the abnormality detection image It (step S201). Alternatively, the processor 40 may cause the first reader 51 to read the whole image forming region 31a or image recordable range and extract the abnormality detection image It from the read data.

The processor 40 averages brightness values of the abnormality detection image It read for each pixel position (image pickup range of the image pickup device) in the feeding direction and acquires a density distribution in the width direction (step S202). The processor 40 acquires a detection reference value of an abnormality corresponding to the set detection sensitivity (step S203). With reference to the abnormality detection level setting 72, the processor 40 acquires any one of the detection reference values DL, DM and DH. The processor 40 determines whether or not there is a density change equal to or greater than the detection reference value within the density distribution (that is, whether or not there is a discharge abnormality of ink from the nozzle) (step S204). When it is determined that there is no density change equal to or greater than the detection reference value (“NO” in step S204), the processor 40 ends the abnormality detection control process.

The processes in steps S201 to S204 constitute a state detection step (operation as a state detector of the processor 40) of the present embodiment.

When it is determined that there is a density change equal to or greater than the detection reference value, that is, it is determined that the recording state is other than a predetermined detection reference and there is an ink discharge abnormality (“YES” in step S204), the processor 40 causes the image former 20 to stop normal image recording operation (step S205). The processor 40 performs a process of identifying a defective nozzle (step S206). When a test image necessary for identification (part of the above-described position identifying image Ip or the like) needs to be outputted, the processor 40 outputs an instruction for forming the test image to the image former 20 and causes the first reader 51 to read the test image formed on the intermediate transfer belt 31. At this time, if the transferrer 30 is configured to be enabled to prevent the image from being transferred from the intermediate transfer belt 31 to the recording media M, the above-described cleaner may be caused to perform a process of erasing the primary image while preventing the primary image from being transferred to the recording media M. Alternatively, if an image from which an abnormality is detected is transferred from the intermediate transfer belt 31 to the recording media M, the transferred recording media M may be separated from the discharge path of the normal recording media M and discharged separately from the recording media M on which the image is normally recorded. In this case, the inkjet recording apparatus 1 is provided with a discharge path changer and a plurality of discharge trays or the like corresponding to the changed discharge paths. The identified defective nozzles are additionally stored in the defective nozzle information 73.

The processor 40 determines whether or not it is possible to make a complementary setting (correction of the recording state) for complementing ink discharge of the identified defective nozzle with other nozzles (step S207). Whether or not the complementary setting is possible is determined based on whether or not the neighboring nozzles already include a defective nozzle, which may be determined according to the method used in this inkjet recording apparatus 1 among various conventionally known complementary setting methods. When it is determined that the complementary setting is possible (“YES” in step S207), the processor 40 makes a complementary setting on the defective nozzle (step S208; correction step, operation as a corrector of the processor 40). The processor 40 permits resumption of the image recording operation and causes the image recording operation to be resumed speedily if there are no other problems. The processor 40 then ends the abnormality detection control process.

Note that the processor 40 may also cause recording operation and reading operation of the abnormality detection image It to which a complementary setting is applied to be performed and resume a normal image recording operation after confirming that the brightness value change falls below the detection reference value. At this time, brightness value changes equal to or higher than a detection reference value may occur continuously without any substantial change in the result of reading the primary image formed on the intermediate transfer belt 31 according to the complementary setting. In this case, such a brightness change may be attributable not to an ink discharge defect but to an adhered substance or scar on the surface of the intermediate transfer belt 31. Therefore, the processor 40 may cause the display 93 or the notification operator 94 to perform predetermined notification operation instead of repeatedly performing a complementary setting. For example, the processor 40 may cause the display 93 to display a suggestion of a possibility of abnormality in the intermediate transfer belt 31.

In the case where it is determined that the complementary setting for ink discharge of a defective nozzle is not possible (“NO” in step S207), the processor 40 stops the image recording operation and causes the notification operator 94 or the display 93 to perform a predetermined abnormality notification operation (step S209). The processor 40 then ends the abnormality detection control process.

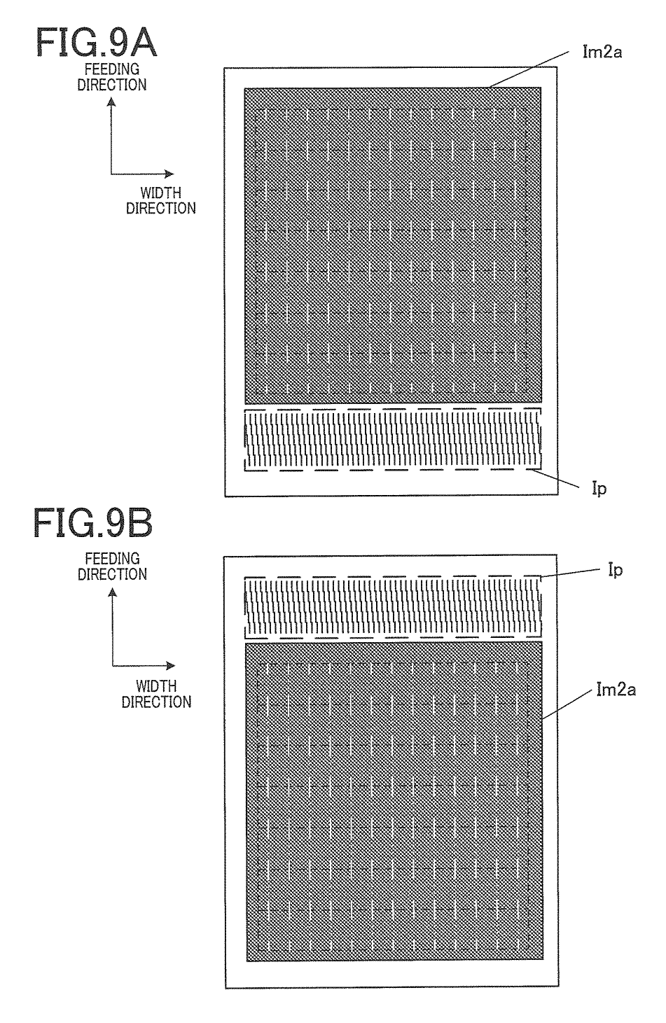

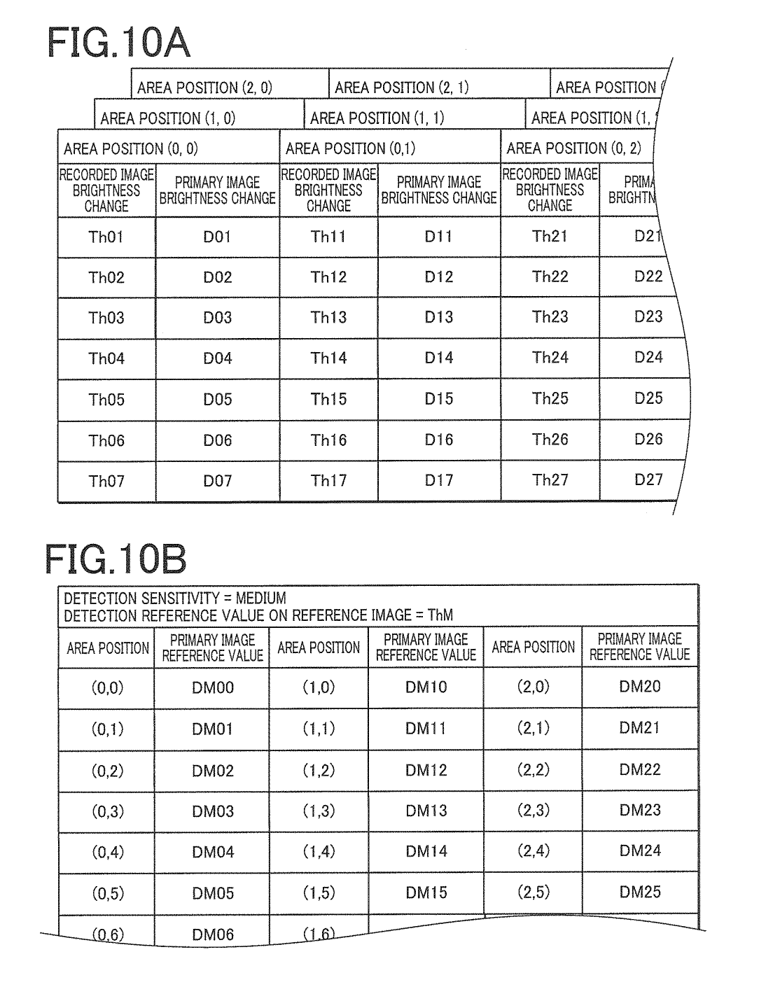

FIG. 9A and FIG. 9B are diagrams illustrating a modification 1 of a test image. FIG. 10A is a table illustrating an example of the abnormality detection reference table 71 corresponding to the modification 1. FIG. 10B is a table illustrating an example of the abnormality detection level setting 72 corresponding to the modification 1.

Although the above description has been given assuming that changes in transfer efficiency on the intermediate transfer belt 31 occur uniformly, there can be a case where changes in transfer efficiency occur non-uniformly within the image forming region 31a. Here, the correspondence relation between a brightness change amount of the non-discharge nozzle corresponding portion read by the aforementioned first reader 51 and a brightness change amount of the non-discharge nozzle corresponding portion read by the second reader 52 is required for each area (p, q) (region) resulting from dividing the image forming region 31a into p×q portions in the width direction and the feeding direction. One of the natural numbers p and q is equal to or greater than 2, and these values may be defined as appropriate depending on the characteristic length associated with a spatial change of the transfer characteristic from the image forming region 31a. That is, the natural numbers p and q may be different values. The aspect ratio of the area (p, q) may not be 1:1 but may be anisotropic.

As shown in FIG. 9A, in the test image Im2a, the non-discharge nozzle corresponding portions corresponding to a predetermined thickness are arranged in a two-dimensional matrix form. In this case, a change in the brightness distribution of the non-discharge nozzle corresponding portions in the part of the position identifying image Ip is not acquired. Therefore, as shown in FIG. 9B, identical primary images are formed a plural number of times while changing recorded portion of the position identifying image Ip with respect to the identical image forming region 31a. Furthermore, as described in FIG. 1, when there are a plurality of image forming regions 31a, identical test image Im2a and position identifying image Ip are formed for each of the image forming regions 31a. In the non-discharge nozzle corresponding portions corresponding to other thicknesses, different test images are arranged likewise and a plurality of position identifying images Ip are formed in each image forming region 31a while shifting the position of the position identifying image Ip.

As shown in FIG. 10A, in this case, a correspondence relation between a brightness change amount detected on primary images of areas (0, 0) to (2, q) for each of the plurality of corresponding acquisition areas (regions) set in the image forming region 31a and a brightness change amount detected in the recording region on the recorded image respectively transferred from these corresponding acquisition areas is each defined and stored as the abnormality detection reference table 71. This corresponding acquisition area can be determined wider than the range in which the aforementioned non-discharge nozzle corresponding portions are set respectively. That is, when a plurality of non-discharge nozzle corresponding portions are included in one corresponding acquisition area, the brightness change amount in the corresponding acquisition area is set with predetermined representative values such as average values or median values of a plurality of brightness change amounts obtained in the corresponding acquisition area.

As shown in FIG. 10B, when one brightness change amount which becomes a reference value allowable on the recording medium is determined (here, reference value ThM, detection sensitivity of which corresponds to “medium”), detection reference values DM00 to DM2q corresponding to this reference value ThM are set for each corresponding acquisition area, and stored as the abnormality detection level setting 72. In the abnormality detection control process during normal image recording shown in FIG. 8, the abnormality detection image It is normally formed in the same region of the image forming region 31a, and it is therefore possible to arrange and set detection reference values in the region where the abnormality detection image It is formed (each of the plurality of image forming regions 31a) in advance and speedily compare them with the brightness value distribution associated with the abnormality detection image It.

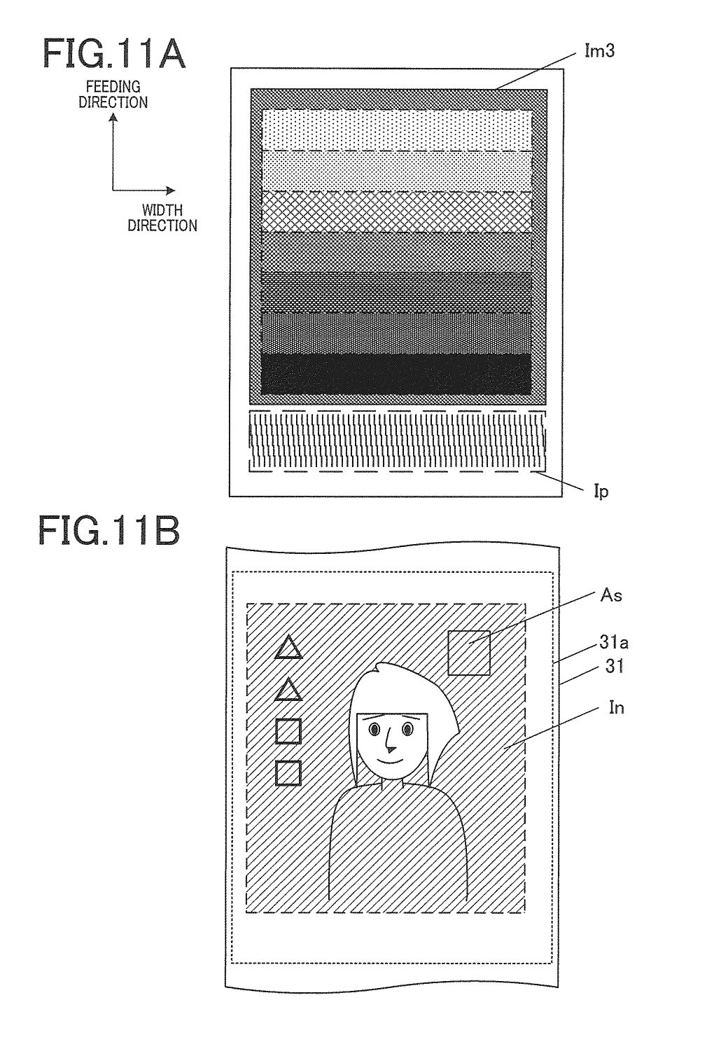

FIG. 11A is a diagram illustrating a modification 2 of a test image Im3. FIG. 11B is a diagram illustrating the modification 2 of a normal image In.

A case has been described above where a test image to detect a discharge abnormality of a nozzle is formed in the intermediate transfer belt 31 and transferred to and recorded on the recording media M, but the test image is not limited to this.

As shown in FIG. 11A, a half-tone image with a plurality of gradations is formed as a test image Im3 here. The inkjet recording apparatus 1 acquires a brightness value of each gradation portion read on the intermediate transfer belt 31 by the first reader 51 and a brightness value of each gradation portion read on the recording media M by the second reader 52, determines the correspondence relation associated with the outputted gradation and stores the respective brightness values together with or instead of the correspondence relation of the aforementioned brightness change amount in the abnormality detection reference table 71.

In the case of detection of a density deviation, the abnormality detection image It need not always be formed in normal recorded images depending on contents of the image. For example, as shown in FIG. 11B, it is possible to calculate a deviation amount of brightness value estimated for the recorded image on the final recording media M and determine whether or not a deviation equal to or greater than a reference value occurs based on the deviation amount with respect to the brightness value estimated for the image on the intermediate transfer belt 31 with respect to the gradation value of the image region As with uniform gradation in the normal image In formed on the intermediate transfer belt 31. In a case of the normal image In with no constant gradation region or a case where an overall gradation variation is detected, an image in which half-tone images with a plurality of gradations are arranged as the abnormality detection image It may be formed for the intermediate transfer belt 31 together with the normal image In.

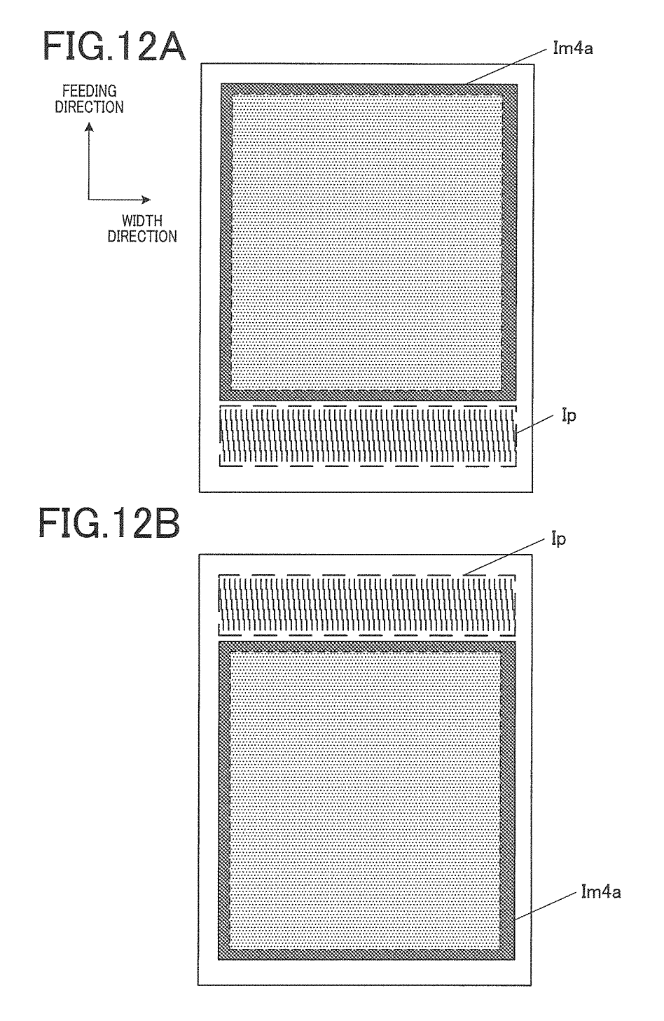

FIG. 12A and FIG. 12B are diagrams illustrating a modification 3 of a test image. As for detection of a density deviation or density variation, as in the case of the modification 1, variations in transfer efficiency or transfer characteristics or the like of the intermediate transfer belt 31 may occur with lapse of time. In this case, a half-tone image with predetermined gradation is formed as a test image Im4a in the image forming region 31a together with the position identifying image Ip and transferred to the recording media M. The reading gradation on the intermediate transfer belt 31 during this gradation image forming is associated with the reading gradation on the recording media M for each corresponding acquisition area and the associated reading gradation is stored in the storage 70.

In this case, it is difficult to detect a spatial density variation in the image forming region 31a unless the normal image In is an image of uniform density over a wide range. Therefore, the processor 40 causes a uniform half-tone image to be recorded on the intermediate transfer belt 31 as the abnormality detection image It every time a predetermined number of normal images In are recorded, and determines whether or not the deviation amount of brightness values in each corresponding acquisition area falls within an allowable range (equal to or less than a reference value). In this case, in the case of a configuration where it is possible to prevent the abnormality detection image It from being transferred to the recording media M, it may be possible to erase using the cleaner, the primary image on the intermediate transfer belt 31 read by the first reader 51 without allowing the primary image to be transferred.

As described above, the detection apparatus provided for the inkjet recording apparatus 1 according to the present embodiment is a detection apparatus which detects a recording state of an image in the inkjet recording apparatus 1 provided with the recording head 211 in which a plurality of ink discharging nozzles are arrayed, the intermediate transfer belt 31 which is impacted by discharged ink to form a primary image and the transferrer 30 that transfers the primary image on the intermediate transfer belt 31 to the recording media M and records the image in the recording media M, the detection apparatus including the first reader 51 that reads a primary image on the intermediate transfer belt 31, the second reader 52 that reads the recorded image transferred to the recording media M and the processor 40 or the like. The processor 40 sets, as a reference setter, a correspondence relation between the first detection value read by the first reader 51 and the second detection value read by the second reader 52 and detects, as a state detector, a recording state of the primary image read by the first reader 51 based on the correspondence relation between the first detection value and the second detection value.

Thus, the detection apparatus can acquire the correspondence relation between the reading result of the first reader 51 and the reading result of the second reader 52 with an appropriate frequency and can normally detect the recording state of an image based on the reading result of the primary image by the first reader 51. That is, it is possible to restrict the correspondence relation between the reading result of the primary image and the reading result of the recorded image from changing and becoming inaccurate with lapse of time, and thereby reduce erroneous detections associated with the problem with the recording state. Therefore, the detection apparatus can appropriately evaluate the degree of image quality degradation of the recorded image more reliably. Furthermore, it is possible to speedily detect the problems before recording images on the recording media M and take necessary measures, and can thereby shorten an interruption time of image recording operation. Furthermore, it is possible to stop transfer to the recording media M or even if it is not possible to directly stop transfer to the recording media M at the early stage, it is possible to stop movement of the intermediate transfer belt 31 or supply of the recording media M, and thereby reduce losses of the recording media M.

Furthermore, the processor 40, as a reference setter, sets detection reference values DL, DM and DH which are first detection values corresponding to second reference values which are second detection values serving as predetermined detection references according to the recording state on the recording media M, for example, image quality degradation caused by ink discharge abnormality, and determines, as a state detector, whether or not the recording state of the primary image satisfies a predetermined detection reference based on the detection reference values DL, DM and DH.

That is, without detecting a final recorded image transferred to the recording media M, the detection apparatus can appropriately detect degradation of the primary image corresponding to the level of degradation of image quality in the recorded image. Therefore, it is possible to efficiently determine final image quality while avoiding making stricter or conversely making too loose the detection reference for image quality degradation in the primary image more than necessary, allowing the inkjet recording apparatus 1 to output recorded images of stable image quality.

Furthermore, the processor 40 as a corrector, can correct a recording state which does not meet the detected predetermined detection reference as the state detector. That is, the processor 40 can speedily detect a recording abnormality before recording the recorded image on the recording medium, correct the recording abnormality and restore the image recording to appropriate image recording that falls within the detection reference range in a short time.

The recording state which does not fall within the detected predetermined detection reference range includes a discharge abnormality of ink from the nozzles. That is, it is possible to reliably detect an ink discharge abnormality affecting image quality of the recorded image from the primary image and speedily take measures or urge the user to take measures.

The discharge abnormality includes a variation in a direction crossing the feeding direction of the intermediate transfer belt 31 of the discharge direction of ink from the nozzles. That is, when ink is not discharged in an appropriate direction though this does not mean that ink is not discharged from the nozzles at all, the degree of influence on degradation in image quality varies depending on the deviation direction and the deviation in the amount of ink discharge. In such a case, since the degree of influence on the primary image is different from the degree of influence on the recorded image, the detection apparatus according to the present embodiment capable of appropriately acquiring and updating the correspondence relation so as to avoid deviations can detect degradation of image quality on the primary image corresponding to the degradation of image quality which becomes a problem on the recorded image appropriately without excess or deficiency. It is thereby possible to restrict degradation of image quality caused by detection omission or deterioration of efficiency due to excessive detection and allow the inkjet recording apparatus 1 to perform image recording operation more efficiently.

Furthermore, the plurality of (16) recording heads 211 constitute a line head, the processor 40 as a reference setter associates a change amount of brightness of a portion corresponding to a non-discharge nozzle that does not discharge ink with a predetermined frequency in a half-tone image with a predetermined density recorded by including the non-discharge nozzle as a first detection value and a second detection value, and stores the change amount as the abnormality detection reference table 71. That is, by generating a brightness change when a defective nozzle simulatively exists, a brightness change on the primary image is associated with a brightness change on the recorded image. It is thereby possible to detect on the primary image, a brightness change corresponding to the brightness change which cause degradation of image quality which becomes a problem on the recorded image and more reliably maintain image quality of the recorded image.

The detection apparatus is also provided with the communicator 91 and the operation receiver 92 as an input receiver which receives an external input, and the reference values ThL, ThM and ThH are defined based on an instruction received by the input receiver. That is, the detection apparatus determines the level of image quality required for the primary image in accordance with final image quality required for the recorded image to be outputted. It is thereby possible to output the recorded image of necessary image quality flexibly and reliably.

Furthermore, the input receiver includes the operation receiver 92 that receives an input operation from outside. That is, the user can directly input and set the level of necessary image quality via the operation receiver 92. Thus, the user can easily adjust the required image quality without the need to change the setting of job data and resend it while confirming the recorded image in the vicinity of the inkjet recording apparatus 1.

Furthermore, the recording state includes a density variation of the recorded image. That is, the detection apparatus can speedily detect a variation of the discharge ink amount of among not only the defective nozzles but also the respective nozzles that individually discharge ink normally within a reference range and cause the inkjet recording apparatus 1 to take measures or urge the user to take measures.

Furthermore, the processor 40 as the reference setter determines a correspondence relation between a first detection value required for each region determined on the intermediate transfer belt 31 and a second detection value in each recording region on the recording media M to which images are transferred from these regions.

That is, when there is nonuniformity in the transfer characteristic or transfer efficiency or the like in each region of the intermediate transfer belt 31, it is possible to determine an appropriate detection reference for abnormalities for each region, and thereby achieve uniform and stable image quality of the whole recorded image.

Furthermore, the inkjet recording apparatus 1 according to the present embodiment is provided with the above-described detection apparatus, the recording head 211 and transferrer 30. Such an inkjet recording apparatus 1 can detect the above-described problems with recording states stably without excess or deficiency and speedily deal with the problems. That is, the inkjet recording apparatus 1 can prevent the correspondence relation between the primary image reading result and the recorded image reading result from becoming inaccurate with lapse of time and reduce erroneous detection associated with the problems with recording states. Therefore, the inkjet recording apparatus 1 can evaluate the degree of degradation of the recorded image more reliably and appropriately. Moreover, since the inkjet recording apparatus 1 can speedily detect problems before recording images on the recording media M and take necessary measures, and can thereby shorten an interruption time during the image recording operation. Therefore, the inkjet recording apparatus 1 can output recorded images of stable image quality efficiently while shortening the interruption time of the image recording operation.

Furthermore, the detection method according to the present embodiment is a detection method for detecting an image recording state in the inkjet recording apparatus 1 including the recording head 211 at which a plurality of ink discharging nozzles are arrayed and the transferrer 30 including the intermediate transfer belt 31 which is impacted by discharged ink to form a primary image, the transferrer 30 transferring the primary image on the intermediate transfer belt 31 to the recording medium M and recording the image on the recording medium M, using the detection apparatus provided with the first reader 51 and the second reader 52. The method includes reading by the first reader 51, the primary image on the intermediate transfer belt 31, reading by the second reader 52, the recorded image transferred to the recording medium M, setting a correspondence relation between the first read detection value and the second read detection value and detecting the recording state from the primary image read by the first reader 51 based on the correspondence relation between the first detection value and the second detection value.

Thus, through the detection method using the first reader 51 and the second reader 52, it is possible to detect the recording state of an image based on only the primary image reading result by the first reader 51 under normal circumstances. That is, it is possible to restrict erroneous detection associated with the problem with the recording stage by preventing the correspondence relation between the primary image reading result and the recorded image reading result from becoming inaccurate with lapse of time. Therefore, this detection method makes it possible to evaluate the degree of image quality degradation of a recorded image more reliably and appropriately.

Note that the present invention is not limited to the above-described embodiment, but can be changed in various ways.

For example, the intermediate transfer body has been descried as the endless intermediate transfer belt 31 in the above embodiment, but the intermediate transfer body may be a cylindrical rotary drum or may be an intermediate transfer body with both ends that makes circulating movement.

Furthermore, although the image forming region 31a is set on the intermediate transfer belt 31 in advance according to the above embodiment, there may be such a structure in which a primary image is formed at any given position of the intermediate transfer belt 31 and the primary image is transferred to the recording media M. In this case, if the transfer characteristic is nonuniform on the intermediate transfer belt 31, the abnormality detection reference table 71 and the abnormality detection level setting 72 are generated in all areas on the intermediate transfer belt 31. Furthermore, when images are corrected, information on the area in which the primary image is formed may be acquired in advance and images may be corrected in correspondence with the area.

In the above embodiment, table data which is the reading value of the primary image associated with the reading value of the recorded image as the abnormality detection reference table 71 is stored in the storage 70, but an approximate expression subjected to linear approximation or fitting may be stored as a correspondence relation.

In the above embodiment, a complementary setting is performed for defective nozzles in an abnormality detection control process substantially in real time so that a recording operation on a normal image can be resumed, but the process may also be configured such that image recording is necessarily interrupted for notification to the user and the recording operation is resumed only after the user's confirmation or approval. The notification operation is not limited to one directly executed by the display 93 or the notification operator 94 in the inkjet recording apparatus 1. Notification to the outside may be performed via the communicator 91 or an outside notification operator may be enabled to operate.

In the above embodiment, detection sensitivity can be set in three stages and a reference value ThL, ThM or ThH (second reference value) is set in accordance with the selected detection sensitivity, but only a single reference value may be settable or the user may be allowed to input/set any given reference value.

In the above embodiment, discharge abnormality nozzles are detected based on a change amount of a brightness value in the non-discharge nozzle corresponding portion, but discharge abnormality nozzles may also be detected in accordance with a maximum value (local maximum value) of the brightness value. Furthermore, discharge abnormality nozzles may also be detected based on a difference between an average brightness value obtained by averaging detection values of the respective image pickup devices in each stage in the feeding direction and a moving average value obtained by further moving-averaging the average brightness value in the width direction by a predetermined width at a time.

Although discharge abnormalities including variations in the discharge direction and density variations have been described with examples in the above embodiment, the recording states to be detected are not limited to these examples.

In the above embodiment, settings of abnormality detection references and abnormality detections which are commonly performed for the head units 21 of any given color have been described, but the selection of reference value ThL, ThM or ThH or settings of other references may differ among different colors.

In the above embodiment, although images are recorded on the intermediate transfer belt 31 through the line head, a scanning type image former 20 may also be provided which forms a primary image while causing the head unit 21 to scan the intermediate transfer belt 31.

In the above embodiment, the CPU 41 of the processor 40 integrally performs control associated with image forming and control associated with abnormality detection, but each control process may be executed by different CPUs or the processor itself may be provided separately.

In addition, specific details such as the specific configuration, control contents and control procedure or the like shown in the above embodiment may be changed as appropriate without departing from the spirit and scope of the present invention.

The contents of the disclosure of Japanese Patent Application No. 2018-22704 which is the Japanese Patent Application submitted on Feb. 13, 2018 are incorporated by reference herein.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

1 Inkjet recording apparatus
10 Medium supplier
11 Intermediate transfer belt
20 Image former
21, 21Y, 21M, 21C, 21K Head unit
210 Head module
211 Recording head
25 Head driver
25a Ink discharge mechanism
27a Nozzle opening
30 Transferrer
31 Intermediate transfer belt
31a Image forming region
32 Drive roller
321 Heating member
322 Encoder
33 Driven roller
34 Supporter
35 Pressurizing roller
36 Heating roller
361 Heating member
37 Roller driver
38 Heating operator
40 Processor
41 CPU
42 RAM
50 Reader
51 First reader
511, 512 Image capturer
513 Illuminator
52 Second reader
521 Image capturer
522 Illuminator
55 Image pickup driver
70 Storage
71 Abnormality detection reference table
72 Abnormality detection level setting
73 Defective nozzle information
91 Communicator
92 Operation receiver
93 Display
94 Notification operator
99 Bus

What is claimed is:

1. A detection apparatus which detects an image recording state in an inkjet recording apparatus,
the inkjet recording apparatus comprising:
a recording head on which a plurality of ink discharging nozzles are arrayed; and
a transferrer comprising an intermediate transfer body which is impacted by discharged ink to form a primary image, the transferrer transferring the primary image on the intermediate transfer body to a recording medium and recording the image on the recording medium,
the detection apparatus comprising:
a first reader which reads the primary image on the intermediate transfer body; and
a second reader which reads the recorded image transferred to the recording medium; and
a processor, wherein
the processor sets a correspondence relation between a first detection value read by the first reader and a second detection value read by the second reader, and
detects the recording state of the primary image read by the first reader based on the correspondence relation.

2. The detection apparatus according to claim 1, wherein
the processor sets a first reference value which is the first detection value corresponding to a second reference value which is the second detection value serving as a predetermined detection reference associated with a recording state on the recording medium, and
determines whether or not the recording state of the primary image satisfies the predetermined detection reference based on the first reference value.

3. The detection apparatus according to claim 2, wherein the processor corrects a recording state which does not meet the detected predetermined detection reference.

4. The detection apparatus according to claim 2, wherein the recording state which does not meet the detected predetermined detection reference includes a discharge abnormality of ink from the nozzles.

5. The detection apparatus according to claim 4, wherein the discharge abnormality includes a variation in a direction crossing a feeding direction of the intermediate transfer body in a direction in which ink is discharged from the nozzles.

6. The detection apparatus according to claim 4, wherein
the recording head constitutes a line head, and
the processor associates a change amount of brightness of a portion corresponding to a non-discharge nozzle that does not discharge ink with a predetermined frequency in an image with a predetermined density recorded by including the non-discharge nozzle as the first detection value and the second detection value.

7. The detection apparatus according to claim 2, further comprising an input receiver which receives an external input, wherein
the predetermined second reference value is defined based on an instruction received by the input receiver.

8. The detection apparatus according to claim 7, wherein the input receiver comprises an operation receiver which receives an input operation from outside.

9. The detection apparatus according to claim 1, wherein the recording state includes a density variation of a recorded image.

10. The detection apparatus according to claim 1, wherein the processor determines for each region, a correspondence relation between the first detection value calculated for each region determined on the intermediate transfer body and the second detection value in each recording region of the recording medium to which images are transferred.

11. An inkjet recording apparatus comprising:
the detection apparatus according to claim 1;
a recording head on which a plurality of ink discharging nozzles are arrayed; and
a transferrer comprising an intermediate transfer body which is impacted by discharged ink to form a primary image, the transferrer transferring the primary image on the intermediate transfer body to a recording medium and recording the image on the recording medium.

12. A detection method for detecting an image recording state in an inkjet recording apparatus comprising a recording head on which a plurality of ink discharging nozzles are arrayed, a transferrer comprising an intermediate transfer body which is impacted by discharged ink to form a primary image, the transferrer transferring the primary image on the intermediate transfer body to a recording medium and recording the image on the recording medium, using a detection apparatus comprising a first reader and a second reader, the method comprising:
reading by the first reader, the primary image on the intermediate transfer body;
reading by the second reader, the recorded image transferred to the recording medium;
setting a correspondence relation between a first read detection value and a second read detection value; and
detecting the recording state from the primary image read by the first reader based on the correspondence relation.
